(19) United States
(12) Patent Application Publication
(10) Pub. No.: US 2005/0082206 A1
(43) Pub. Date: Apr. 21, 2005

(54) Screen for a pulp strainer

(76) Inventor: Ching-Hu Lin, Shenkang Hsiang (TW)

Correspondence Address: DELLETT AND WALTERS, P. O. BOX 2786, PORTLAND, OR, 97208-2786, US

(21) Appl. No.: 10/677,924

(22) Filed: Oct. 1, 2003

(51) Int. Cl. B07B 1/26; B07B 1/20

(52) U.S. Cl. 209/305; 209/301

(57) ABSTRACT

A screen for a pulp strainer has a tubular body, multiple columns of slots and multiple strips. The body has an axis, a wall with an inner surface and an outer surface and multiple columns of undulating segments formed on the wall along the axis. Each undulating segment has multiple wave crests and troughs perpendicular to the axis of the body. The columns of slots are longitudinally defined through the wall of the tubular body. Each slot is defined in one of the troughs of the undulating segments on the wall and has an inlet and an outlet. The inlet has a height smaller than that of the outlet. The strips are mounted on the wall and are located respectively between adjacent columns of undulating segments.

### BACKGROUND OF THE INVENTION

1. Field of the Invention

The present invention relates to a screen, and more particularly to a screen for a pulp strainer that has an excellent efficiency for filtering the pulp.

2. Description of Related Art

With reference to FIG. 6, a conventional screen for a pulp strainer in accordance with the prior art comprises a tubular body (30), multiple slots (not numbered) and multiple reinforcing rings (35). The tubular body (30) has an axis (not numbered) and a wall (31). The wall has an outer surface (not numbered) and a longitudinal undulating inner surface (not numbered) with multiple wave crests (not numbered) and troughs (not numbered) arranged along the axis in an alternating arrangement. The slots are longitudinally defined through the wall (31) and are located respectively in the troughs of the undulating inner surface. Each slot has an inlet (322) and an outlet (321). The inlet (322) of each slot is defined in the inner surface of the wall (31), and the outlet (321) is defined in the outer surface of the wall (31). The inlet (321) of each slot has a width smaller than that of the outlet (322). The reinforcing rings (35) are mounted around the tubular body (30) on the outer surface of the wall (31) to enhance the structural strength of the screen.

In operation, the screen is put into an outer housing and a stirring device is mounted in the screen to stir the pulp received in the screen. Some of the pulp that is smaller than the width of the inlets (322) will be allowed to pass through the slots, and a filtering effect to the pulp is provided.

However, because the slots in the conventional screen are longitudinally defined in the tubular body (30), the pulp does not easily pass through the slots that are substantially perpendicular to the flowing direction of the pulp stirred by the stirring device. In addition, with the arrangement of the reinforcing rings (35), parts of the slots will be blocked. Consequently, the area of the slots for the pulp to pass through is reduced, and the efficiency of filtering the pulp provided by the conventional screen is low.

In addition, because the wave crests of the undulating inner surface are substantially perpendicular to the flowing direction of the pulp, the wave crests will be easily worn off after a period of use. After the wave crests of the undulating inner surface have been worn off, the vortexes in the flowing pulp generated due to the interruption effect provided by the wave crests is reduced. Therefore, the speed of the flowing pulp on the inner surface of the wall (31) is decreased, and the pulp travelling at a low speed easily blocks the slots.

To overcome the shortcomings, the present invention tends to provide a screen to mitigate or obviate the aforementioned problems.

### SUMMARY OF THE INVENTION

The main objective of the invention is to provide a screen for a pulp strainer that can improve the efficiency for filtering the pulp. The screen has a tubular body, multiple columns of slots and multiple strips. The body has an axis, a wall with an inner surface and an outer surface and multiple columns of undulating segments formed on the wall along the axis of the body. Each undulating segment has multiple wave crests and troughs perpendicular to the axis of the body and arranged in alternating manner. The columns of slots are longitudinally defined through the wall of the tubular body. Each slot is defined in one of the troughs of the undulating segments on the wall and has an inlet and an outlet. The inlet has a height smaller than that of the outlet. The strips are mounted on the wall and are located respectively between adjacent columns of undulating segments.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a screen for a pulp strainer in accordance with the present invention;

FIG. 2 is an enlarged perspective view in partial section of part of the tubular body with slots of the screen in FIG. 1;

FIG. 3 is an enlarged cross sectional top plan view of the tubular body of the screen in FIG. 1;

FIG. 4 is an enlarged cross sectional side plan of part of the tubular body with slots of the screen in FIG. 1;

FIG. 5 is an enlarged cross sectional top plan view of a second embodiment of a tubular body of a screen in accordance with the present invention; and

FIG. 6 is a perspective view of a conventional screen for a pulp strainer in accordance with the prior art.

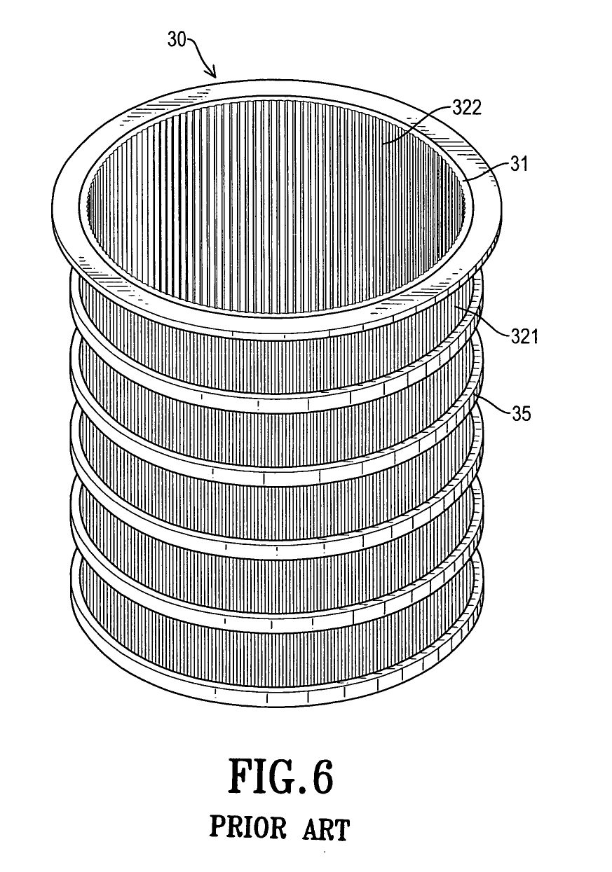

### DETAILED DESCRIPTION OF PREFERRED EMBODIMENT

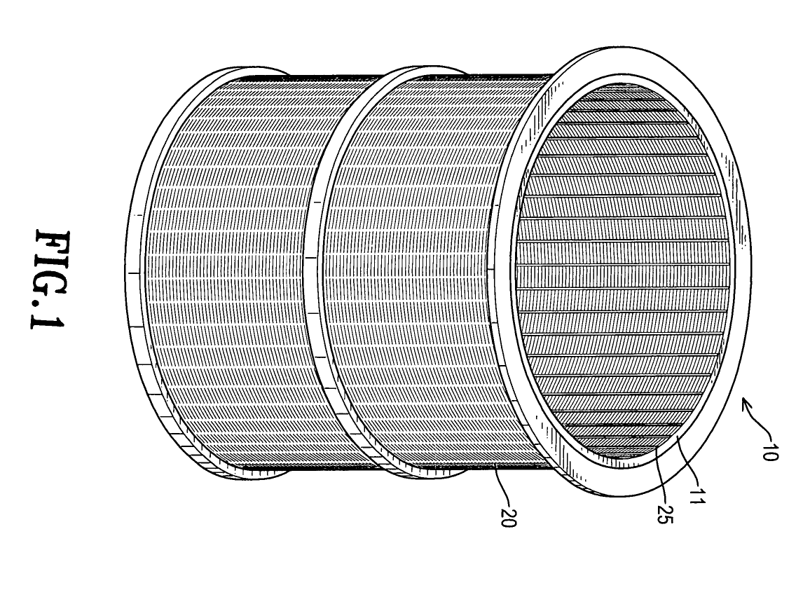

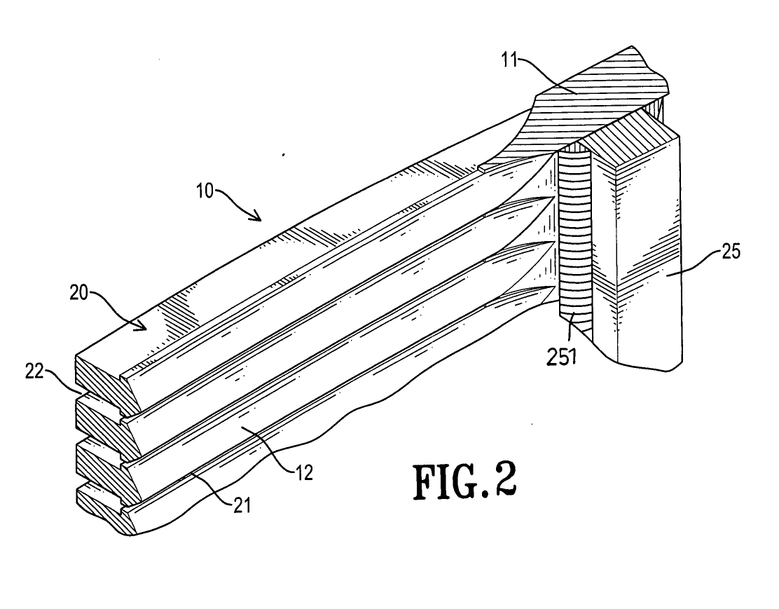

With reference to FIGS. 1 and 2, a screen for a pulp strainer in accordance with the present invention comprises a tubular body (10), multiple columns of slots (20), multiple strips (25) and optionally at least one reinforcing ring (not numbered). The body (10) has an axis (not numbered) and a wall (11) with an outer surface (not numbered) and an inner surface (not numbered). The wall (11) has multiple columns of undulating segments (12) formed along the axis of the body (10). Each undulating segment (12) has multiple wave crests (not numbered) and troughs (not numbered) perpendicular to the axis of the body (10) and arranged in an alternating manner. In a first embodiment, the undulating segments (12) are formed on the inner surface of the wall (11).

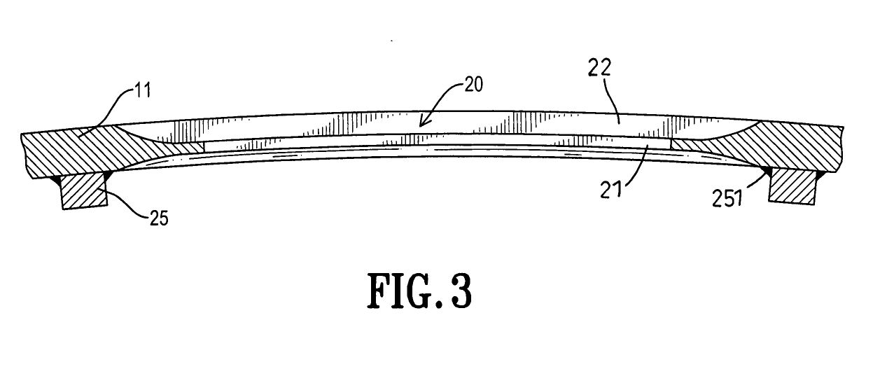

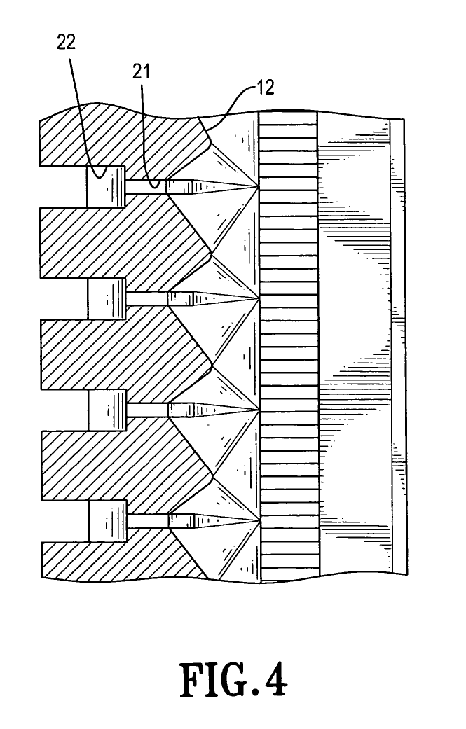

With further reference to FIGS. 3 and 4, the slots (20) are laterally defined respectively in the troughs of the undulating segments (12) on the wall (11). Each slot (20) has an inlet (21) and an outlet (22). Each inlet (21) has a height smaller than that of the corresponding outlet (22). In the first embodiment, the inlet (21) is defined in the inner surface of the wall (11), and the outlet (22) is defined in the outer surface of the wall (11).

The strips (25) are securely mounted on the wall (11) and are located respectively between adjacent columns of undulating segments (12). In the first embodiment, the strips (25) are securely mounted on the inner surface of the wall (11) by a welding process with weld (251).

The optional at least one reinforcing ring is mounted around the tubular body (10) on the outer surface of the wall (11).

In the first embodiment, a stirring device (not shown) is received in the screen and an outer housing (not shown) is mounted around the screen to achieve a pulp strainer. After the pulp being put into the screen and the stirring device being switched on, some of the pulp particles that are smaller than the height of the inlets (21) of the slots (20) are allowed to pass through the slots (20). Accordingly, a filtering effect to the pulp is provided. Because the slots (20) are laterally defined in the wall (11) of the tubular body (10) and are substantially along the flowing direction of the pulp stirred by the stirring device, the pulp will pass through the slots (20) in ease. In addition, with the arrangement of the lateral slots (20), the total area of the slots (20) for the pulp passing through is enlarged even though there are reinforcing rings mounted on the tubular body (10). In an experiment, a screen in accordance with the present invention has about 10% increased area compared to a conventional screen of the same size. Thus, the efficiency for filtering the pulp is improved.

In addition, with the arrangement of the strips (25), vortexes are generated on the inner surface of the wall (11) when the pulp passes over the strips (25). Accordingly, the speed of the pulp on the inner surface of the wall (11) is increased, and this can keep the inlets (21) of the slots (20) from being blocked by the pulp. Moreover, the strips (25) also provide a reinforcing effect to the structural strength of the screen, so the reinforcing rings on the outer surface of the tubular body (10) can be optionally omitted.

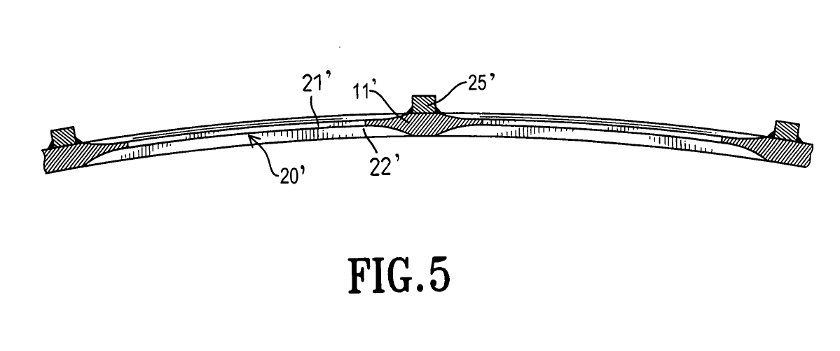

With reference to FIG. 5, in a second embodiment, the undulating segments are formed on the outer surface of the wall (11′) of the tubular body, and the strips (25′) are mounted on the outer surface of the wall (11′). The inlets (21′) of the slots (20′) are defined in the outer surface of the wall (11′), and the outlets (22′) are defined in the inner surface of the wall (11′).

In the second embodiment, an outer housing (not shown) is mounted around the screen and a stirring device (not shown) is mounted between the outer housing and the screen to achieve another pulp strainer. The pulp is put into the space between the outer housing and the screen and is stirred by the stirring device to flow into the screen through the slots (20′).

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A screen for a pulp strainer comprising:
a tubular body with an axis having a wall with an inner surface and an outer surface and multiple columns of undulating segments formed on the wall along the axis of the body, and each undulating segment having multiple wave crests and troughs perpendicular to the axis of the body and the wave crests and troughs arranged in an alternating manner;
multiple columns of slots longitudinally defined through the wall of the tubular body; and
multiple strips mounted on the wall and located respectively between adjacent columns of the undulating segments,
wherein each slot is laterally defined in one of the troughs of the undulating segments on the wall and has an inlet with a height and an outlet with a height larger than that of the inlet.

2. The screen as claimed in claim 1, wherein the undulating segments are formed on the inner surface of the wall of the tubular body;
the strips are mounted on the inner surface of the wall;
the inlets of the slots are defined in the inner surface of the wall; and
the outlets are defined in the outer surface of the wall.

3. The screen as claimed in claim 2 further comprising at least one reinforcing ring mounted on the outer surface of the wall.

4. The screen as claimed in claim 1, wherein
the undulating segments are formed on the outer surface of the wall of the tubular body;
the strips are mounted on the outer surface of the wall;
the inlets of the slots are defined in the outer surface of the wall; and
the outlets are defined in the inner surface of the wall.
